(19) United States
(12) Patent Application Publication
(10) Pub. No.: US 2025/0392920 A1
(43) Pub. Date: Dec. 25, 2025

(54) CHANNEL ALLOCATION

(71) Applicant: Ekahau Oy, Helsinki (FI)

(72) Inventors: Teemu Pulkkinen, Espoo (FI); Janne Kurjenniemi, Jyväskylä (FI)

(21) Appl. No.: 18/878,836

(22) PCT Filed: Jun. 14, 2023
(86) PCT No.: PCT/FI2023/050356

§ 371 Date: Dec. 24, 2024

(30) Foreign Application Priority Data
Jul. 8, 2022 (FI) FI20225650

(51) Int. Cl. H04W 16/12; H04W 16/14; H04W 16/18

(52) U.S. Cl. CPC H04W 16/12; H04W 16/14; H04W 16/18

(57) ABSTRACT

A channel allocation solution taking into account how much service areas of access points overlap is discussed. In the solution, using obtained radio spectrum information, an overlap measure per an access point is determined, the overlap measure indicating how much service area of the access point overlaps with service areas of other access points. The access points are then sorted to an order by the overlap measure, and channels are allocated to the access points according to the order.

### FIELD

The invention relates to allocation of channels to access points in a wireless network.

### BACKGROUND

A typical wireless network, for example a wireless local area network, includes a plurality of access points providing wireless radio access to client devices. In addition to placing the access points, also channels are allocated to the access points in order to the network being able to operate. Channel allocation tools usually allocate channels to access points based on distance between access points and/or estimated radio interferences between access points. The thus obtained channel allocation may not be optimal in view of a client device, with a possible result that the wireless network is not operating properly for the client device.

### SUMMARY

The invention relates to a method, an apparatus, a computer readable medium and a computer program defined in the independent claims. The preferred embodiments are disclosed in the dependent claims.

An aspect introduces a solution, in which radio spectrum information is used to determine, per an access point, an overlap measure indicating how much its service area overlaps with other service areas. Channels are allocated to access points in a sorted order, which is based on overlap measures. By taking into account, per an access point, how much a service area overlaps with other service areas, views of client devices are included to the channel allocation process, since in overlapping service areas client devices may be in contention even though neighboring access points are not in contention.

### BRIEF DESCRIPTION OF THE DRAWINGS

In the following different embodiments of the invention will be described in greater detail with reference to the attached drawings, in which:

FIG. 1 illustrates an exemplified apparatus;

FIGS. 2 and 3 illustrate examples of functionalities; and

FIG. 4 is a schematic block diagram.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s)/example(s), or that the feature only applies to a single embodiment/example. Single features of different embodiments/examples may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the elements are not restricted by the terms. The terms are used merely for the purpose of distinguishing an element from other elements.

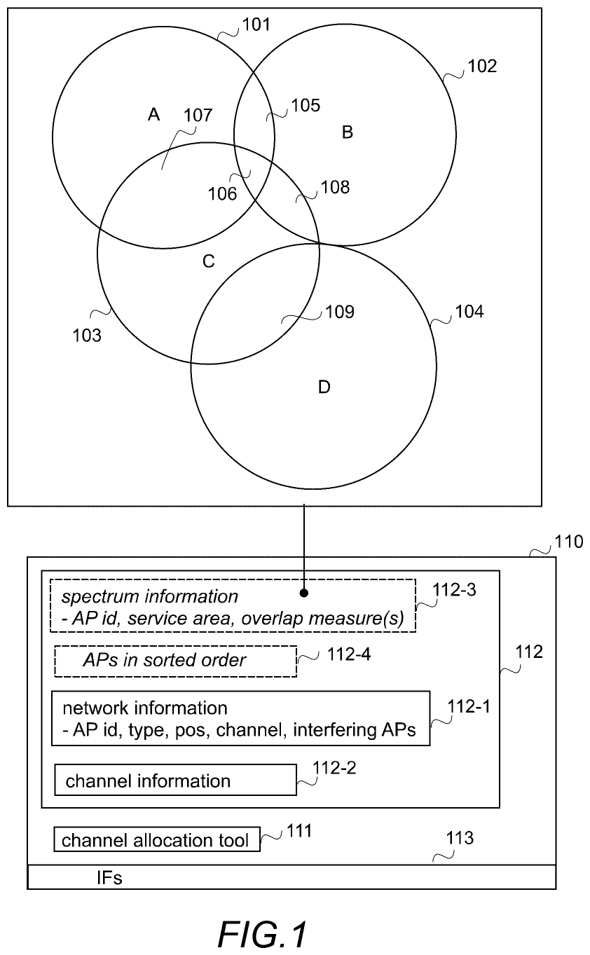

FIG. 1 illustrates a simplified apparatus describing only some logical units with their operative connections, the implementation of which may deviate from what is presented. It is obvious to a person skilled in the art that the apparatus may also comprise other functions and structures that need not be described in greater detail here, or be part of a computing environment comprising one or more apparatuses. The more detailed structure of the apparatus or a computing environment is irrelevant to the actual invention, and therefore is not described in more detail herein.

Referring to FIG. 1, the apparatus 110 may be any computing device that can be configured to run at least one channel allocation tool 111 that is configurable to allocate channels to access points in a wireless network (wireless network environment) using principles disclosed in detail below. The wireless network may be an existing network or a network to be deployed according to a network plan. A wireless network may support one frequency band, two frequency bands, three frequency bands, etc. In view of channel allocation process disclosed below, the different frequency bands can be seen as separate wireless networks, i.e. the channel allocation may be performed per a frequency band. Hence, herein the term “access point” means a radio operable in one frequency band.

Further, the apparatus 110 comprises one or more memories 112 (only one illustrated in FIG. 1) to store information relating to a wireless network, or per a wireless network, if the memory stores information on a plurality of wireless networks.

The memory 112 may store network information 112-1. A non-limiting list of examples of the network information 112-1 includes, per an access point of a plurality of access points, identifying information (AP id), access point type information, access point's position (pos) in in the wireless network (or in a corresponding network plan), allocated (assigned) channel, if any allocated, information on interfering access points (APs), etc. An interfering access point is usually a neighbor access point. The information on interfering access points may comprise estimated radio interference per an interfering access point.

The memory 112 may store channel information 112-2, for example per a frequency band. The channel information 112-1 may comprise available channels on the frequency band, and per a channel, status information indicating whether the channel is free (i.e. not allocated/not assigned to any access point) or allocated (assigned/non-free). The available channels are a group of channels that can be allocated, i.e. that are supported and usable. The number of available channels may vary between different frequency bands and even for one frequency band, depending on the region or network environment, especially in unlicensed frequency bands. For example, in 2.4 GHz frequency band in North America channels 1-11, or less, are available, and in Europe channels 1-13, or less, are available.

The memory 112 may store, at least temporarily for the channel allocation procedure, radio spectrum information 112-3 on the wireless network, i.e., radio spectrum information on a plurality of the access points. The radio spectrum information 112-3 comprises at least per an access point, indicated for example by identifying information (AP id) of the access point, service area of the access points, or information based on which the service area can be determined. Using the highly simplified example illustrated in FIG. 1, the radio spectrum information may comprise at least: access point A-service area 101; access point B-service area 102; access point C-service area 103; access point D-service area 104, etc. It should be appreciated that a service area may have any shape, and size. At least during the channel allocation process the radio spectrum information may comprise, per the access point, one or more overlap measures. An overlap measure indicates how much a service area of an access points overlaps with one or more service areas of corresponding one or more other access points, and it is determined during the channel allocation procedure. In the example of FIG. 1, different overlaps are denoted by 105, 106, 107, 108, 109. It should be noted that an access point indicated in the network information as an interfering access point, may not actually have any overlapping service area, and thereby the access nodes do not interfere with each other. For example, if the interfering access point for the access point D are the access points C, B, A, the access point A being the least interfering, it can easily be seen that the access points A and D have no overlapping service areas.

Further, the memory 112 may store, at least temporarily during the channel allocation procedure, the access points (APs) in a sorted order 112-4, or at least access points to which no channel has been yet allocated in the sorted order 112-4.

The apparatus 110 further comprises one or more interfaces (IF)s 113, for example for outputting the channel allocations, for receiving network information or updates to network information, one or more user interfaces, for example for receiving user inputs. The outputting may include configuring, or setting, automatically the access points to use the allocated channels, for example by signaling to an access point a channel allocated to the access point and/or providing, for example by displaying, a person configuring on site the access points, information on the channels allocations. Still a further possibility include storing the channel allocation to be part of a network plan to be deployed. In one implementation there may be an interface for receiving the radio spectrum information from an external simulation tool that has simulated the wireless network, for example its radio patterns, and/or for receiving measurement result on radio patterns of the wireless network as the radio spectrum information.

The apparatus 110 may comprise also other tools, not illustrated in FIG. 1, for example a simulation tool to simulate the wireless network, and/or a network planning tool.

The apparatus 110 illustrated in FIG. 1 represents one example which may be implemented by one apparatus. Non-limiting examples of such apparatuses include a dedicated server, a distributed computing device that may use cloud computing or grid computing, and a user terminal or a workstation, such as a laptop, a smartphone, a personal computer, a tablet computer, a field device, augmented reality equipment, and virtual reality equipment.

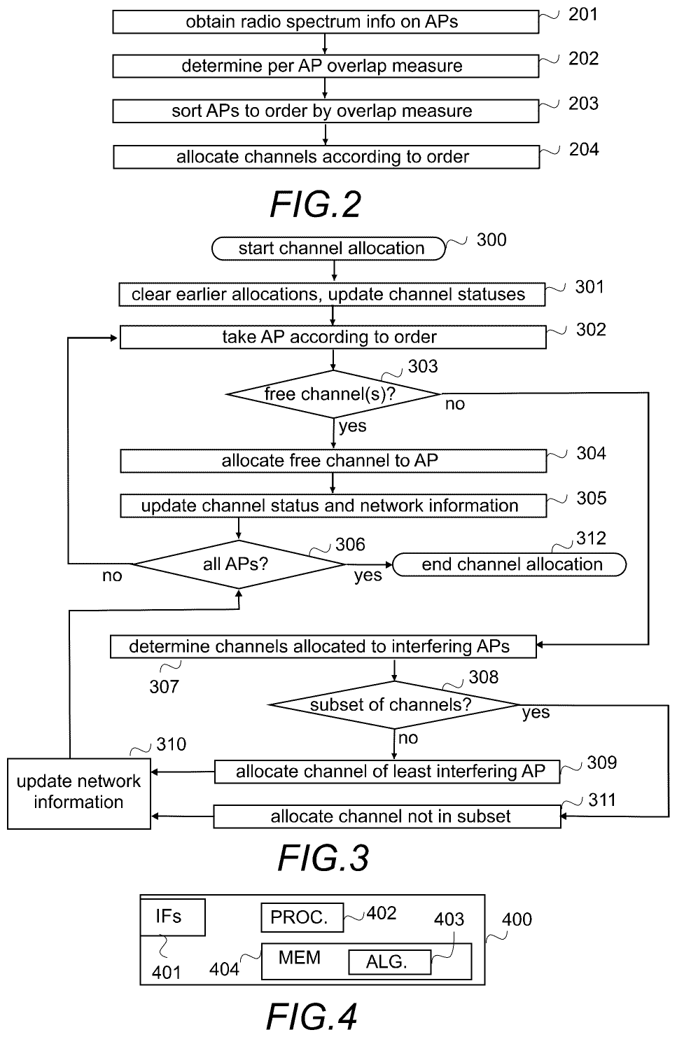

FIG. 2 is a flow chart illustrating an exemplified functionality of an apparatus, or more precisely a channel allocation tool comprised in the apparatus, configured to automatically allocate channels to access points. When the wireless network is implemented to support two or more frequency bands, for example 2.4 GHz, 5 GHz and 6 GHz frequency bands, the functionality is performed per a frequency band, to allocate corresponding 2.4 GHz channels, 5 GHz channels and 6 GHz channels. The channel allocation tool may be run when a wireless network is taken into use, or when one or more access point are added, removed and/or replaced, and/or updated radio spectrum information is received, as if no channels have been allocated.

Referring to FIG. 2, radio spectrum information on a plurality of access points for a wireless network is obtained in step 201. As said with FIG. 1, the radio spectrum information comprises service areas of access points, or information based on which the service areas may be determined, in which case the obtaining includes determining the service areas. The obtaining in step 201 may be performed by receiving measurement result on radio patterns of the wireless network, or by simulating the wireless network. The simulating may be performed in the apparatus, or in another apparatus, wherefrom simulation results are obtained. In a further embodiment, the obtaining may comprise obtaining part of the radio spectrum information by receiving measurement result and part by simulating the wireless network. Any known or future tool may be used for simulation or for measurements. For example, commercially available off-the-shelf products or tools, such as Wi-Fi analyzers, map-based surveying tools, and network simulators, can be used to obtain the radio spectrum information.

Then, per an access point, an overlap measure of the access point is determined in step 202. For example, a number of overlapping service areas may be determined as the overlap measure in step 202. Using the number example and the spectrum information illustrated in FIG. 1, following overlap measures may be determined: A—2 (overlaps with B and C); B—2 (overlaps with A and C); C—3 (overlaps with A, B and D); D—1 (overlaps with C). In another example, an area covered by the one or more overlapping service areas may be determined as the overlap measure in step 202. Using the area example and the spectrum information illustrated in FIG. 1, following overlap measures may be determined: A—area of 105+106+107; B—area of 105+106+108; C—area of 107+106+108+109; D—area of 109. In another example, a sum area of the one or more overlapping service areas may be determined as the overlap measure in step 202. Using the sum area example and the spectrum information illustrated in FIG. 1, following overlap measures may be determined: A—area of 105+106+106+107 (overlap with B+overlap with C); B—area of 105+106+106+108 (overlap with A+overlap with C); C—area of 107+106+106+108+109 (overlap with A+overlap with B +overlap with D); D—area of 109 (overlap with C). In another example, an area ratio, i.e. a ratio of the area to the service area of the access point, may be determined as the overlap measure in step 202. Using the area ratio example and the spectrum information illustrated in FIG. 1, following overlap measures may be determined: A—(area of 105+106+107)/area of 101; B—(area of 105+106+108/area of 102; C—(area of 107+106+108+109)/area of 103; D—area of 109/area of 104. In another example, a sum area ratio, i.e. a ratio of the sum area to the service area of the access point, may be determined as the overlap measure in step 202. Using the sum area ratio example and the spectrum information illustrated in FIG. 1, following overlap measures may be determined: A—(area of 105+106+106+107)/area of 101; B—(area of 105+106+106+108)/area of 102; C—(area of 107+106+106+108+109)/area of 103; D—area of 109/area of 104. It should be appreciated that the above are non-limiting examples. For example, the overlap measure may comprise two or more of the above overlap measures, as hierarchical overlap measure, or combined for example by multiplying or by summing up. For example, the ratios may be summed up, or the area and number multiplied.

When the overlap measures have been determined, the access points are sorted in step 203 by the overlap measure so that the access points are after the sorting in an order (sorted order). The sorting may include applying one or more criteria to determine the order for access points having the same overlap measure. An example of a criterium is the size of the service area. In another example, the hierarchical order of overlap measures provides the criteria. For example, the hierarchical order may be the number, the area, the sum area, etc. Using the example based on FIG. 1, the order based on the number is C, A or B, D, and then it is checked, whether the area can be used to sort A and B to an order. In the illustrated example, the area can be used, and the order will be C, A, B, D.

Then the channel allocation tool automatically allocates in step 204, channels to the access points according to the order, starting preferably from the access points with the biggest overlap measure. In other words, using the above example, a channel is allocated first to C, then to A, then B and then to D.

FIG. 3 illustrates a more detailed example how the channels may be allocated in step 204.

Referring to FIG. 3, the channel allocation process for a frequency band is started in step 300. The process may start in step 301 by resetting all channels to be free and updating the network information to contain no channel allocations. In implementations, in which there are one or more access points with fixed channels, the process may remove the access point(s) with the fixed channel(s) from the order, and maintain status of the fixed channels as allocated (non-free) and the channel allocations in the network information.

Then the process takes in step 302, according to the order, an access point to which a channel is to be allocated. In the process free channels are allocated to the access point according to the order as long as there are free channels to allocate within available channels for channel allocation. Hence, it is checked in step 303, whether there are one or more free channels.

If there is (step 303: yes), a free channel is allocated in step 304 to the access point. When there are two or more free channels, a channel to be allocated may be selected randomly or using a selection rule. For example, at the beginning when there are plurality of free channels to choose, the process may choose when no channels have been allocated, a channel that is in one edge of the frequency band, and after that, a channel that is, in terms of frequency, the furthest away channel from an already allocated channel or the last allocated channel, and if there are multiple such channels, the one of the multiple channels, which is, in terms of the frequency, furthest away from the channel allocated to the most interfering access point that has been allocated a channel. In another example, channels are allocated using running number, for example, channel #1 is allocated to the first access point in the order, channel #2 to the second access point in the order, etc. When the channel has been allocated, the status of the channel is updated in step 305 to be “allocated”, and the network information of the access point is updated in step 305 to indicate the channel.

Then the process continues to step 306 to check, whether channel has been allocated to all access points. If not (step 306: no), the process proceeds to step 302 to take the next access point in the order to be the access point to which the channel is allocated.

When there are no free channels to allocate within the available channels (step 303: no), in the illustrated example, channels allocated to interfering access points are determined in step 307. The channels allocated to the interfering access points may be called a first set of channels. Then it is checked, in step 308, whether the first set of channels is a subset of the available channels. If the channels allocated to the interfering access points contain all available channels, i.e. the first set is the same as a set of the available channels, (step 308: no) may be called a first set of channels, a least interfering access point is determined, and a channel allocated to the least interfering access point is allocated in step 309 to the access point, and the network information of the access point is updated in step 310 to indicate the channel. Then the process continues to step 306 to check, whether channel has been allocated to all access points.

If the first set of channels is a subset of the available channels (step 308: yes), a channel within a second set, i.e. a set of one or more channels that are not part of the first set, is allocated in step 311 to the access point. For example, a channel in the second set that is the least used may be allocated to the access point, or the channel may be randomly selected. Then the network information of the access point is updated in step 310 to indicate the channel, and the process continues to step 306 to check, whether channel has been allocated to all access points.

When channel has been allocated to all access points (step 306: yes), the channel allocation process ends (step 312).

Using the example of FIG. 1, the order of access point C, A, B, D, and assuming that interfering access points have overlapping service areas and assuming available channels #1, #2, the process of FIG. 3 would first allocate channel #1 to C, and then allocate channel #2 to A. After that there are no free channels. To allocate a channel to B, the process determines the first set of channels, which is channels #1, #2. The first set is the same as the available channels, and assuming that A is the least interfering, the process allocates channel #2 to B. To allocate channels to D, the process determines the first set of channels, which is channel #1. The first set is a subset, not comprising channel #2, and hence channel #2 is allocated to D. Then the process ends with following channel allocation: A—channel #2; B—channel #2; C—channel #1; D—channel #2.

Using the example of FIG. 1, the order of access point C, A, B, D, and assuming that for B interfering access points are C, D, and A, for D interfering access points are C, B and A, and assuming available channels #1, #2, the process of FIG. 3 would first allocate channel #1 to C, and then allocate channel #2 to A. After that there are no free channels. To allocate a channel to B, the process determines the first set of channels, which is channels #1, #2. The first set is the same as the available channels, and since A is the least interfering of the access points to which a channel is allocated, the process allocates channel #2 to B. To allocate channels to D, the process determines the first set of channels, which is channels #1, #2. The first set is the same as the available channels, and since A is the least interfering of the access points to which a channel is allocated, the process allocates channel #2 to D. Then the process ends with following channel allocation: A—channel #2; B—channel #2; C—channel #1; D—channel #2.

As can be seen from the above examples, an optimized channel allocation procedure, which reduces contention experienced, or likely to be experienced, by client devices, is disclosed. The optimized channel allocation procedure prioritizes access points that experience the most contention with other access points in the wireless network environment. A specific channel allocated to an access point has been allocated by taking into account access points contending for the same service area(s), the specific channel being selected in a manner that minimizes the contention with the competing access points. In other words, in the optimized channel allocation procedure, perspective of access points and, by means of the overlap measure, perspective of client devices, are taken into account.

As is evident from the above, the present invention is applicable to be used with any wireless radio channel allocation application (tool). The type of the wireless networks is irrelevant, as well as the frequency bands available. For example, one or more channel allocations may be for a network according to fifth generation (5G) system, beyond 5G, and/or wireless networks based on IEEE 802.xx specifications, such as IEEE 802.11 (WLAN) and IEEE 802.15, or any combination thereof. 5G has been envisaged to use a so-called small cell concept including macro sites operating in co-operation with smaller local area access points (access nodes), including mobile access nodes, and also employing a variety of radio technologies, for example incorporating both cellular (3GPP) and non-cellular (e.g. IEEE) technologies.

The steps and related functions described above in FIGS. 2 and 3 are in no absolute chronological order, and some of the steps/related functions may be performed simultaneously or in an order differing from the given one. Other functions can also be executed between the steps or within the steps. For example, configuring an access point to use a channel allocated to the access point may be performed within an allocation step, or as a last step of a channel allocation process. Some of the steps or part of the steps can also be left out or replaced by a corresponding step or part of the step. Further, the described processes and steps within processes, may run in parallel, for example when channels are allocated to access points per a frequency band.

The techniques and methods described herein may be implemented by various means so that an apparatus/equipment/a device configured to provide the channel allocation tool, or to perform re-run according to at least partly on what is disclosed above with any of FIGS. 1 to 3, including implementing one or more functions/operations described above with an embodiment/example, for example by means of any of FIGS. 1 to 3, comprises not only prior art means, but also means for implementing the one or more functions/operations of a corresponding functionality described with an embodiment/example, for example by means of any of FIGS. 1 to 3, and the apparatus may comprise separate means for each separate function/operation, or means may be configured to perform two or more functions/operations. Apparatuses (devices, equipments) may generally include one or more processors, controllers, control units, micro-controllers, or the like connected to one or more memories and to various interfaces of the apparatus, configured to implement the channel allocation tool. For example, one or more of the means and/or any tool described above may be implemented in hardware (one or more devices), firmware (one or more devices), software (one or more modules), or combinations thereof.

FIG. 4 is a simplified block diagram illustrating some units for an apparatus 400 configured to provide the functionality described above with FIGS. 1 to 3, comprising at least the channel allocation tool with the re-run functionality (assisting functionality), or an apparatus 400 comprising some of the corresponding functionality if functionalities are distributed in the future.

Referring to FIG. 4, the apparatus 400 comprises one or more interfaces (IFs) 401 for obtaining for example spectrum information, and/or network information, updates to network information. The one or more interfaces may comprise one or more user interfaces for user interaction. The apparatus 400 further comprises one or more processors 402 configured to implement the functionality described above with FIGS. 1 to 3, or at least part of corresponding functionality as a sub-unit functionality if a distributed scenario is implemented, with corresponding algorithms 403, and one or more memories 404 usable for storing a computer program code required for the functionality of the apparatus, including the channel allocation tool, i.e. the algorithms for implementing the functionality. The memory 404 is also usable for storing at least temporarily other information, such as the channel information, network information, spectrum information and/or sorted order(s).

Generally a processor 402 is a central processing unit, but the processor may be an additional operation processor. The channel allocation tool and/or algorithms described herein may be configured as a computer or a processor, or a microprocessor, such as a single-chip computer element, or as a chipset, including at least a memory for providing storage area used for arithmetic operation and an operation processor for executing the arithmetic operation. The one or more processors may comprise one or more computer processors, application-specific integrated circuits (ASIC), digital signal processors (DSP), digital signal processing devices (DSPD), programmable logic devices (PLD), field-programmable gate arrays (FPGA), graphics processing units (GPUs), logic gates and/or other hardware components that have been programmed and/or will be programmed by downloading computer program code (one or more algorithms) in such a way to carry out one or more functions described above. An embodiment provides a computer program embodied on any client-readable distribution/data storage medium or memory unit(s) or article(s) of manufacture, comprising program instructions executable by one or more processors/computers, which instructions, when loaded into an apparatus/device, constitute the channel allocation tool, or a plugin, for example, to an existing channel allocation tool. Programs, also called program products, including software routines, program snippets constituting “program libraries”, applets and macros, can be stored in any medium and may be downloaded into an apparatus. In other words, each or some or one of the tools and/or the algorithms described above may be an element that comprises one or more arithmetic logic units, a number of special registers and control circuits.

The memory 404 may generally include volatile and/or non-volatile memory, for example EEPROM, ROM, PROM, RAM, DRAM, SRAM, double floating-gate field effect transistor, firmware, programmable logic, etc. and typically store content, data, or the like. In other words, the one or more memories 404 may be of any type (different from each other), have any possible storage structure and, if required, being managed by any database management system. It is to be noted that the memory, or part of it, may be any computer-usable non-transitory medium within the processor/apparatus or external to the processor/apparatus, in which case it can be communicatively coupled to the processor/apparatus via various means as is known in the art. Examples of an external memory include a removable memory detachably connected to the apparatus, a distributed database and a cloud. The memory may also store computer program code such as software applications (for example, for one or more of the tools) or operating systems, information, data, content, or the like for the processor to perform steps associated with operation of the apparatus in accordance with examples/embodiments.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

What is claimed is:

1. A computer implemented method comprising:
obtaining radio spectrum information on a plurality of access points for a wireless network, the radio spectrum information indicating, per an access point, a service area of the access point;
determining, per an access point, an overlap measure of the access point, the overlap measure indicating how much the service area of the access point overlaps with one or more service areas of corresponding one or more other access points;
sorting the access points by the overlap measure so that the access points are after the sorting in an order; and
allocating channels to the access points according to the order.

2. The computer implemented method of claim 1, wherein the determining of the overlap measure of the access point comprises at least one of:
determining a number of overlapping service areas;
determining an area covered by the one or more overlapping service areas;
determining a sum area of the one or more overlapping service areas;
determining a ratio of the area to the service area of the access point;
determining a ratio of the sum area to the service area of the access point.

3. The computer implemented method of claim 1, wherein the allocating channels comprises:
allocating free channels, which are channels not allocated to any access point, to the access points according to the order as long as there are free channels to allocate within available channels for channel allocation;
when there are no free channels to allocate within the available channels, determining, per an access point to which a channel is to be allocated, a first set of channels which are channels allocated to interfering access points, and in response to the first set being a subset of the available channels, allocating to said access point a channel not belonging to the subset, otherwise determining a least interfering access point and allocating to the access point a channel allocated to the least interfering access point.

4. The computer implemented method of claim 1. wherein the radio spectrum information is obtained by receiving measurement results on radio patterns of the wireless network.

5. The computer implemented method of claim 1, wherein the radio spectrum information is obtained by simulating the wireless network.

6. (canceled)

7. (canceled)

8. (canceled)

9. (canceled)

10. A non-transitory computer readable medium comprising instructions which, when executed by an apparatus, cause the apparatus, after the apparatus has obtained radio spectrum information on a plurality of access points for a wireless network, the radio spectrum information indicating, per an access point, a service area of the access point to carry out:
determining, per an access point, an overlap measure of the access point, the overlap measure indicating how much the service area of the access point overlaps with one or more service areas of corresponding one or more other access points;
sorting the access points by the overlap measure so that the access points are after the sorting in an order; and
allocating channels to the access points according to the order.

11. The computer readable medium of claim 10, further comprising instructions which, when executed by the apparatus, cause the apparatus to carry out the determining of the overlap measure of the access point by at least one of:
determining a number of overlapping service areas;
determining an area covered by the one or more overlapping service areas;
determining a sum area of the one or more overlapping service areas;
determining a ratio of the area to the service area of the access point;
determining a ratio of the sum area to the service area of the access point.

12. The computer readable medium of claim 10, further comprising instructions which, when executed by the apparatus, cause the apparatus to carry out the allocating channels by performing:
allocating free channels, which are channels not allocated to any access point, to the access points according to the order as long as there are free channels to allocate; within available channels for channel allocation
when there are no free channels to allocate within the available channels, determining, per an access point to which a channel is to be allocated, a first set of channels which are channels allocated to interfering access points, and in response to the first set being a subset of the available channels, allocating to said access point a channel not belonging to the subset, otherwise determining a least interfering access point and allocating to the access point a channel allocated to the least interfering access point.

13. (canceled)

14. (canceled)

15. (canceled)

16. An apparatus comprising at least one processor, and at least one memory including computer program code stored thereon which, when executed by at least one of the at least one processor, cause the apparatus at least to:
obtain radio spectrum information on a plurality of access points for a wireless network, the radio spectrum information indicating, per an access point, a service area of the access point;
determine, per an access point, an overlap measure of the access point, the overlap measure indicating how much the service area of the access point overlaps with one or more service areas of corresponding one or more other access points;
sort the access points by the overlap measure so that the access points are after the sorting in an order; and
allocate channels to the access points according to the order.

17. The apparatus of claim 16, wherein the overlap measure of the access point is determined based on at least one of:
a number of overlapping service areas;
an area covered by the one or more overlapping service areas;
a sum area of the one or more overlapping service areas;
a ratio of the area to the service area of the access point; or
a ratio of the sum area to the service area of the access point.

18. The apparatus of claim 16, the computer program code, when executed, further cause the apparatus to:
allocate free channels which are channels not allocated to any access point, to the access points according to the order as long as there are free channels to allocate within available channels for channel allocation;
when there are no free channels to allocate within the available channels, determine, per an access point to which a channel is to be allocated, a first set of channels which are channels allocated to interfering access points, and in response to the first set being a subset of the available channels, allocate to said access point a channel not belonging to the subset, otherwise determine a least interfering access point and allocate to the access point a channel allocated to the least interfering access point.
